(19) United States
(12) Patent Application Publication
(10) Pub. No.: US 2005/0022453 A1
(43) Pub. Date: Feb. 3, 2005

(54) Electrical actuator for swing and similar gates

(76) Inventor: Giuseppe Bosio, Castenedolo (Brescia) (IT)

Correspondence Address: MCGLEW & TUTTLE, PC, 1 SCARBOROUGH STATION PLAZA, SCARBOROUGH, NY, 10510-0827, US

(21) Appl. No.: 10/628,704

(22) Filed: Jul. 28, 2003

(51) Int. Cl. E05F 11/24

(52) U.S. Cl. 49/343; 49/339

(57) ABSTRACT

The invention concerns a command and release device for an electrical actuator for swing gates, that includes a transmission joint comprised of a coupling with frontal teeth (20,21) inserted between the output shaft of gear motor and a worm screw (14) and a release element (24). This element is associated in a radial way to the said coupling so that it can be manually released in an emergency. The release element is comprises an eccentric pin that engages the coupling element in a radial way that can be moved from an engagement position to a release position by being turned by a lock barrel (26) with its key.

### FIELD OF THE INVENTION

This invention concerns in general the field of the motorised closing systems, it concerns in particularly an electrical actuator for swing and similar gates, and it refers especially to improved control and release means for these actuators.

### PRIOR ART

Electrical actuators for opening and closing swing gates are already known. At one end they are fitted to a fixed upright and at the other end to the gate to be moved. These actuators essentially include, inside a casing or protection housing, a non-reversible electrical gear motor that turns a worm screw engaging a nut screw via a transmission joint. The nut screw is fixed to a cylinder or drive rod connected in turn to the swing gate by a drive pin.

The nut screw and the drive pin arranged in this way translate axially without turning and therefore the rotation in either direction of the worm screw by way of the gear motor causes the opening and closing of the swinging gate.

In general, with the motor switched off, the command and transmission system must be mechanically non-reversible to keep the swing gate rigidly blocked so as to impede the involuntary or undesired manual movement of the same. But equally well, the transmission system must be able to be released and disconnected when desired, in order to allow to open/close the swing gate also manually in the event of an emergency, or when no power reaches the gear motor.

Also, in actuators known until today, even though the rod is enclosed in a distal part of the casing or protection housing, it generally has to operate in a protruding position as there are no specific intermediate supports. This arrangement has the drawback for the rod of being subject to bending and deviation with respect to the optimum trajectory, especially when the rod finds itself in the maximum extension position under force.

### OBJECT AND A SUMMARY OF THE INVENTION

One of the objects of this invention is to provide an electrical actuator for swing gates that incorporates a drive transmission system and a release mechanism that are improved through a special arrangement and combination of the functional elements.

Another object of the invention is to propose an electrical actuator of the type and for the use cited above, in which the translating member connectable to the swing gate is supported and guided positively along its entire stroke to keep it constantly aligned with the drive screw.

According to the invention, these objects are achieved with a command and release device for an electrical actuator for swing gates conforming at least to the characterising part of claim 1.

### BRIEF DESCRIPTION OF THE DRAWINGS

Further details of the invention are made evident from the following description with reference to the enclosed guideline and non-limiting drawings in which:

FIG. 1 shows a perspective view of the actuator of the invention;

FIG. 2 shows a longitudinal section of the actuator in FIG. 1;

FIG. 3 shows a longitudinal section according to the arrows A-A on FIG. 2;

FIG. 4 shows an enlarged part of FIG. 3;

FIG. 5 shows an enlarged transverse section according to arrows B-B on FIG. 3.

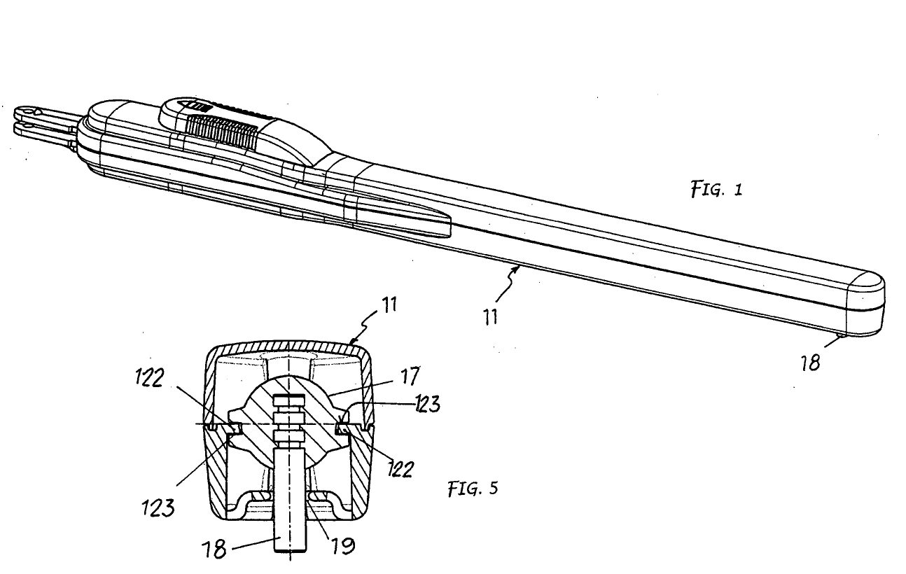

### DETAILED DESCRIPTION OF THE INVENTION

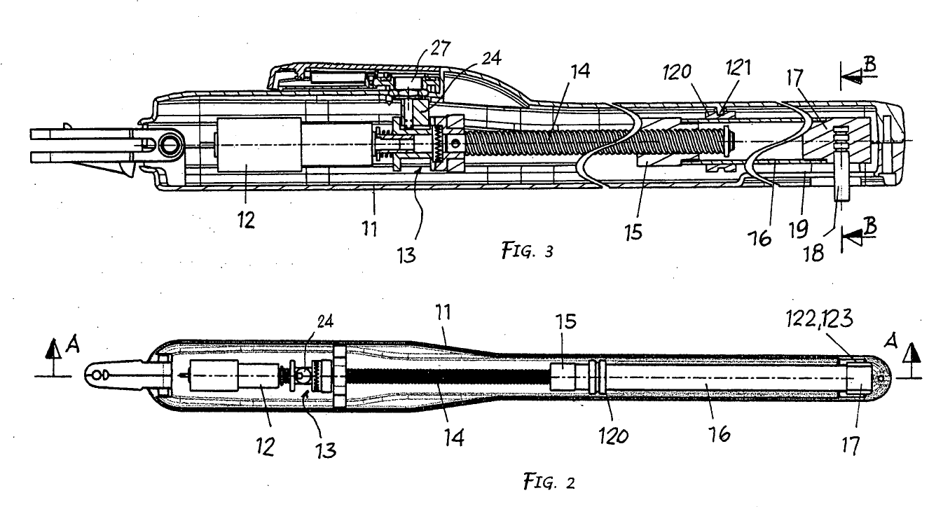

As represented in the drawings, the actuator includes a casing or protection housing 11 which encloses a non-reversible electrical gear motor 12 supplied with either low voltage or mains voltage. The gear motor 12 has an output shaft 12′ that via a transmission coupling 13 actuates the rotation of a non-reversible worm screw 14, which engages a translating, but not rotating, nut screw 15, together with a rod or cylinder 16 also inside the casing or protective housing—FIG. 2. The rod 16 is fixed at its proximal end with the nut screw 15, whilst at its distal end it has a head 17 provided with a drive pin 18 that passes and runs in a slit 19 formed along the casing or protection housing and it connects to a swing gate to be commanded, but not represented here.

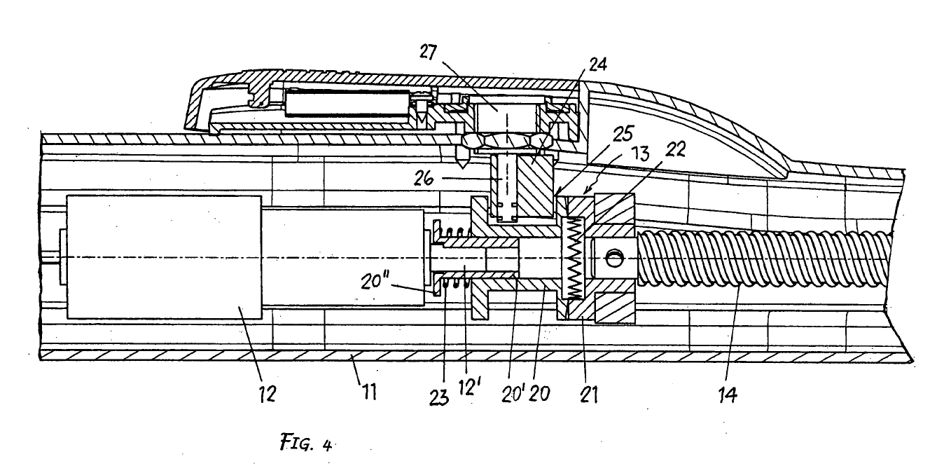

In particular, the transmission coupling 13 is composed of a drive element 20 which is keyed on and axially sliding on the output shaft 12′ of the gear motor 12, with possibly the interposition of a sleeve 20′, and a driven element 21 fixed at the proximal end of the worm screw 14—FIG. 4.

The drive and driven elements 20, 21 both have frontal teeth 22 for reciprocal engagement when found in a close position and that disengage from each other when moved apart. Their coming together and engaging is ensured by a thrust spring 23 associated to the drive element 20, between this and a shoulder collar 20″ around the sleeve 20′. In this condition, the motor commands the worm screw to translate the drive rod and therefore moves the swing gate connected to it.

In the event of an emergency, the drive element 20 can be moved away from the driven element 21 to interrupt the transmission chain at the level of the coupling 13 so as to allow to release the swing gate for manual opening/closing.

For this interruption, the drive element 20 can be moved backwards against the action of the thrust spring 23, by way of an eccentric release pin 24, that engages an annular groove 25 around the drive element in a radial fashion. The eccentric pin 24 can be moved from an engagement blocking position of the coupling to a release position by rotating by way of a lock barrel 26 with a respective key which may be of the lobe, security type, etc.

The lock barrel 26 and the eccentric pin 24 can be reached with the key from the outside of the casing through an opening 27 that normally remains hidden by a masking element.

According to another aspect—FIG. 3—a centring collar 120 withheld axially in the body 11 by a stop 121 is fitted to the rod 16. Two horizontal guide ribs 122 are provided in a longitudinal direction in the casing or protection housing facing each other at least in the part corresponding to the rod 16. On opposite sides of the head 17 of the rod 16, two guide grooves 123 are created that couple with the guide ribs 122, as represented in detail in FIG. 5.

The casing or protection housing is usually composed of two complementary shells, and the guide ribs 122 are advantageously formed integrally on one of these shells thus being part of the same.

The rod is therefore supported both by the centring collar 120 and by the horizontal guides 122, 123 all along its outward and inward stroke. In this way it is never in a protruding position.

1. An electrical actuator for swing gates with a command and release device, comprising, inside a casing or protection housing (11), a non-reversible electrical gear motor (12) actuating via a transmission joint (13) the rotation of a non-reversible worm screw (14) that engages a nut screw (15), and where the nut screw has an axially translating cylinder or rod (16) connected thereto, which in turn is fixed to the swing gate to be commanded through a drive pin (18) located on a distal end of said cylinder or rod, characterized in that said transmission joint comprised of a coupling with frontal teeth (20, 21) inserted between an output shaft (121) of the gear motor (12) and the worm screw (14) and in that a release element (24) is associated in a radial manner to the said coupling for a manual disengagement of the device in the case of emergency.

2. The actuator according to claim 1, in which the said transmission joint (13) is comprised of a drive element (20) keyed onto and sliding directly or indirectly on the output shaft (12) of the gear motor (12) and a drive element (21) fixed to a proximal end of the worm screw (14), and where the drive and driven elements (20, 21) both have frontal teeth (22) for reciprocal engagement when they are close and for disengagement when moved apart.

3. The actuator according to claim 1, in which a thrust spring (23) is associated to the drive element (20) to keep the two elements (20, 21) of the coupling in the engaged condition, and in which the release element (24) is coupled to the said drive element to move it away from the driven element and to disengage the coupling.

4. The actuator according to claim 3, in which the release element is comprised by an eccentric pin (24) associated with an annular groove (25) on the periphery of the drive element, said eccentric pin being rotatable from a engagement position to a release position of the coupling through the rotation of a lock barrel (26) by a respective key, that can be of the lobe, security type or similar.

5. An electrical actuator for swing gates comprising, inside a casing or protection element (11), a non-reversible electrical gear motor (12) actuating via a transmission joint (13) the rotation of a non-reversible worm screw (14), that engages a nut screw (15) to which an axially translating cylinder or rod is connected (16) which in turn is fixed to the swing gate to be commanded through a drive pin (18) located on a distal end of said rod, wherein the transmission joint comprises a coupling with frontal teeth (20, 21) inserted between an output shaft (12′) of the gear motor and the worm screw (14), and a release element (24) associated in a radial manner to the said coupling for a manual disengagement of the device in the case of emergency;
said this coupling being comprised of a drive element (20), keyed onto and sliding directly or indirectly on said output shaft (12′) of the gear motor (12) and a driven element (21) fixed to a proximal end of the worm screw (14) with the drive and driven elements (20, 21) both having frontal teeth (22) for reciprocal engagement when they are close under the action of a spring and for release from each other when they are moved away from the release element; and
said release element being comprised of an eccentric pin (24) that engages an annular groove (25) in a radial way arranged around the drive element movable between an engagement position and a release position of the coupling through the rotation of a lock barrel (26) by a respective key that can be of the lobe, security type or similar.

6. The actuator according to claim 5 wherein:
said casing or protection housing is provided with horizontal guides (122) in a horizontal direction; and
said translating rod or cylinder is centered and slides at one part in a stationary entering collar (120) and in another part is provided with lateral guides (123), that engage with the horizontal guides (122) inside the casing or protection housing to support the rod or the cylinder throughout its entire translation stroke.

7. The electrical actuator according to claim 6, wherein the said horizontal guide elements (122) are comprised of ribs integral to one part of the casing or protective housing extending along the same in correspondence with said rod or cylinder.

8. The electrical actuator according to claim 6, wherein the said centering collar (120) is withheld axially in the casing or protective housing and wherein the said lateral guides (123) of the rod or cylinder (16) are on opposite sides to a head located at the distal end of the rod or cylinder itself

9. The actuator according to claim 2, in which a thrust spring (23) is associated to the drive element (20) to keep the two elements (20, 21) of the coupling in the engaged condition, and in which the release element (24) is coupled to the said drive element to move it away from the driven element and to disengage the coupling.

10. The electrical actuator according to claim 7, wherein the-said centering collar (120) is withheld axially in the casing or protective housing and wherein the said lateral guides (123) of the rod or cylinder (16) are on opposite sides to a head located at the distal end of the rod or cylinder itself
